(19) United States
(12) Patent Application Publication
(10) Pub. No.: US 2025/0168699 A1
(43) Pub. Date: May 22, 2025

(54) METHODS AND APPARATUS FOR PACKET DATA CONVERGENCE PROTOCOL (PDCP) TRANSMIT BUFFER HANDLING

(71) Applicant: INTERDIGITAL PATENT HOLDINGS, INC., Wilmington, DE (US)

(72) Inventors: Oumer Teyeb, Montreal (CA); Martino Freda, Laval (CA); Tuong Hoang, Montreal (CA)

(73) Assignee: INTERDIGITAL PATENT HOLDINGS, INC., Wilmington, DE (US)

(21) Appl. No.: 18/835,093

(22) PCT Filed: Feb. 9, 2023
(86) PCT No.: PCT/US2023/012727

§ 371 Date: Aug. 1, 2024

Related U.S. Application Data
(60) Provisional application No. 63/308,334, filed on Feb. 9, 2022.

(51) Int. Cl. H04W 28/06; H04W 40/22

(52) U.S. Cl. CPC H04W 28/06; H04W 40/22

(57) ABSTRACT

A wireless transmit/receive unit (WTRU) includes a processor and a transceiver that receive a PDCP configuration for a split bearer. The PDCP configuration includes information about first and second discard time periods. The processor stores a first packet and a second packet in a PD-CP transmit buffer. The processor and transceiver start the first discard time period and transmit the first packet over the primary path and start the second discard time period and transmit the second packet over the secondary path. The processor and transceiver discard the first packet stored in the PDCP transmit buffer based on one of expiry of the first discard time period or the receipt of an acknowledgement (ACK) for the first packet, and discard the second packet stored in the PDCP transmit buffer based on one of expiry of the second discard time period or receipt of an ACK for the second packet.

### CROSS-REFERENCE TO RELATED APPLICATIONS

This application claims the benefit of U.S. Provisional Application No. 63/308,334, filed Feb. 9, 2022, the contents of each are incorporated herein by reference.

### BACKGROUND

In Long Term Evolution (LTE), capability for wireless transmit/receive units (WTRUs) to use relaying via proximity services (ProSe) WTRU-to-Network relays was introduced to extend network coverage to out of coverage WTRUs by using PC5 (device-to-device) between an out of coverage WTRU and a WTRU-to-Network relay. A ProSe WTRU-to-Network relay may provide a generic layer 3 (L3) forwarding function that can relay any type of IP traffic between a remote WTRU and the network. The remote WTRUs and the ProSe WTRU-to-Network relay may, for example, communicate using one-to-one and one-to-many sidelink communications. For both the remote WTRU and a Relay WTRU, only one single carrier (e.g., the Public Safety ProSe Carrier) operation may be supported. In other words, Uu and PC5 should be the same carrier for the relay WTRU and the remote WTRU. The remote WTRU may be authorized by upper layers and can be in-coverage of the public safety ProSe carrier or out-of-coverage of any supported carriers including the public safety ProSe carrier for WTRU-to-Network Relay discovery, selection/reselection, and communication. The ProSe WTRU-to-Network relay may always be in-coverage of an Evolved Universal Terrestrial Radio Access Network (EUTRAN). The ProSe WTRU-to-Network relay and the Remote WTRU may perform sidelink communication and sidelink discovery.

### SUMMARY

A wireless transmit/receive unit (WTRU) includes a processor and a transceiver that receive a PDCP configuration for a split bearer. The PDCP configuration includes information about first and second discard time periods. The processor stores a first packet and a second packet in a PDCP transmit buffer. The processor and transceiver start the first discard time period and transmit the first packet over the primary path and start the second discard time period and transmit the second packet over the secondary path. The processor and transceiver discard the first packet stored in the PDCP transmit buffer based on one of expiry of the first discard time period or receipt of an acknowledgement (ACK) for the first packet, and discard the second packet stored in the PDCP transmit buffer based on one of expiry of the second discard time period or receipt of an ACK for the second packet.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of an example user plane radio protocol stack for a layer 2 (L2) evolved WTRU-to-Network relay (PC5);

FIG. 3 is a block diagram of an example control plane radio protocol stack for an L2 evolved WTRU-to-Network relay (PC5);

FIG. 4 is a network diagram of an example of multipath operation via direct (Uu) link and relayed (PC5) link;

FIG. 5 is a functional view of an example packet data convergence protocol (PDCP) layer;

FIG. 6 is a flow diagram of an example method, which may be implemented in an apparatus, such as the WTRU illustrated in FIG. 1B; and

FIG. 7 is a flow diagram of another example method, which may be implemented in an apparatus, such as the WTRU illustrated in FIG. 1B.

### DETAILED DESCRIPTION

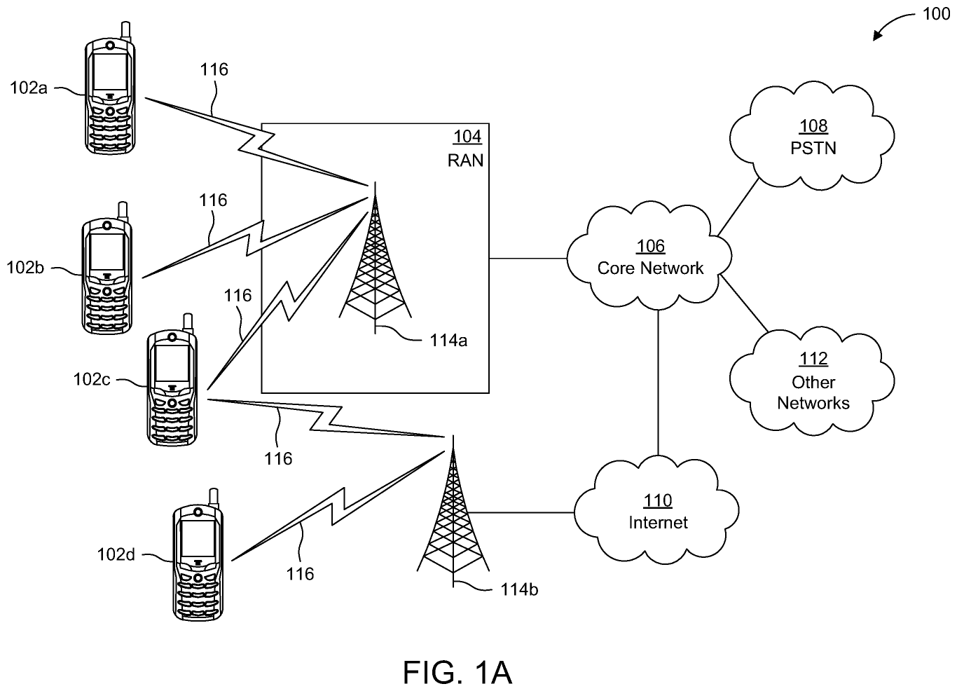

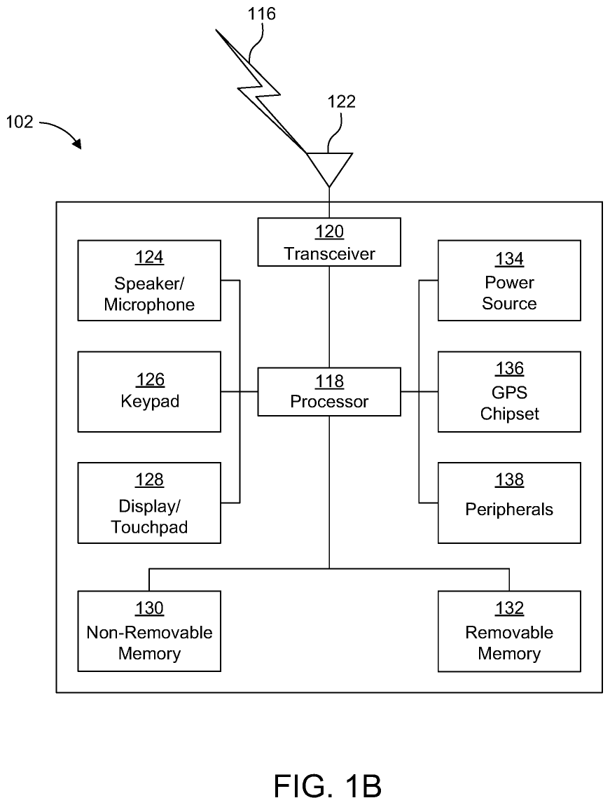

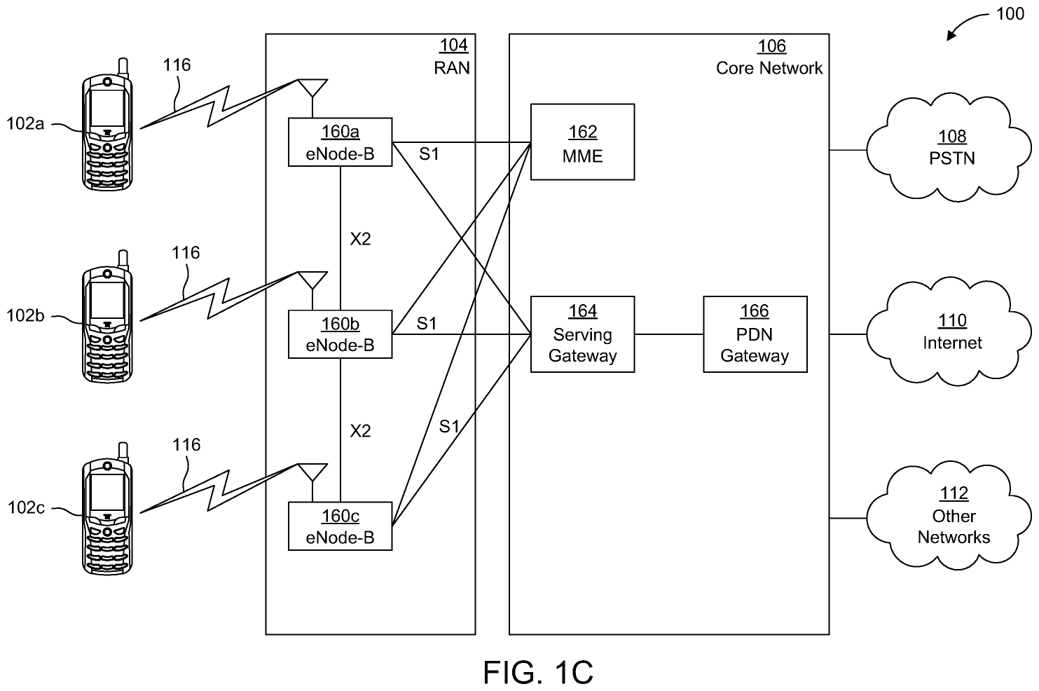

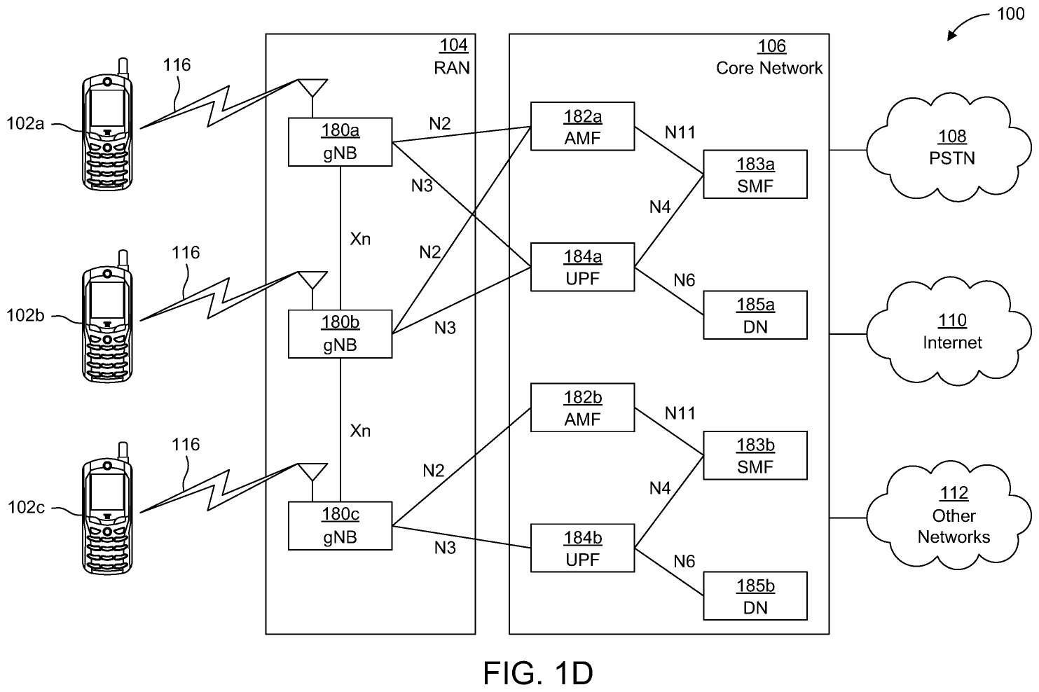

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel—cadmium (NiCd), nickel—zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Relay selection/reselection for ProSe WTRU-to-Networks relays may be performed based on a combination of access stratum (AS) layer quality measurements, such as reference signal received power (RSRP) measurements, and upper layer criteria. The eNode-B (eNB) may control whether the WTRU can act as a ProSe WTRU-to-Network relay. If the eNB broadcast any information associated with a ProSe WTRU-to-Network relay operation, the ProSe WTRU-to-Network relay operation may be supported in the cell, and the eNB may provide transmission resources for ProSe WTRU-to-Network relay discovery using broadcast signaling for the RRC_IDLE state and dedicated signaling for the RRC_CONNECTED state and/or reception resources for ProSe WTRU-to-Network relay discovery using broadcast signaling. The eNB may broadcast a minimum and/or a maximum Uu link quality (e.g., RSRP) threshold or thresholds that the ProSe WTRU-to-Network relay may need to respect before it can initiate a WTRU-to-Network relay discovery procedure. In RRC_IDLE, when the eNB broadcasts transmission resource pools, the WTRU may use the threshold or thresholds to autonomously start or stop the WTRU-to-Network relay discovery procedure. In RRC_CONNECTED, the WTRU may use the threshold or thresholds to determine if it can indicate to the eNB that it is a relay WTRU and wants to start ProSe WTRU-to-Network relay discovery.

If the eNB does not broadcast transmission resource pools for ProSe-UE-to-Network relay discovery, then a WTRU can initiate a request for ProSe WTRU-to-Network relay discovery resources by dedicated signaling, respecting the broadcasted threshold or thresholds. If the ProSe WTRU-to-Network relay is initiated by broadcast signaling, it can perform ProSe WTRU-to-Network relay discovery when in RRC_IDLE. If the ProSe WTRU-to-Network Relay is initiated by dedicated signaling, it can perform relay discovery as long as it is in RRC_CONNECTED.

A ProSe WTRU-to-Network relay performing sidelink communication for ProSe WTRU-to-Network relay operation has to be in RRC_CONNECTED. After receiving a layer-2 (L2) link establishment request or temporary mobile group identity (TMGI) monitoring request or other upper layer message from the remote WTRU, the ProSe WTRU-to-Network relay may indicate to the eNB that it is a ProSe WTRU-to-Network relay and intends to perform ProSe WTRU-to-Network relay sidelink communication. The eNB may provide resources for ProSe WTRU-to-Network Relay communication.

A remote WTRU can decide when to start monitoring for ProSe WTRU-to-Network relay discovery. The remote WTRU can transmit ProSe WTRU-to-Network relay discovery solicitation messages while in RRC_IDLE or in RRC_CONNECTED depending on the configuration of resources for ProSe WTRU-to-Network relay discovery. The eNB may broadcast a threshold, which may be used by the remote WTRU to determine if it can transmit ProSe WTRU-to-Network relay discovery solicitation messages, to connect or communicate with a ProSe WTRU-to-Network relay WTRU. The RRC_CONNECTED remote WTRU uses the broadcasted threshold to determine if it can indicate to the eNB that it is a remote WTRU and wants to participate in ProSe WTRU-to-Network relay discovery and/or communication. The eNB may provide transmission resources using broadcast or dedicated signaling and reception resources using broadcast signaling for ProSe WTRU-to-Network relay operation. The remote WTRU may stop using ProSe WTRU-to-Network relay discovery and communication resources when the RSRP goes above the broadcasted threshold. The exact timing of traffic switching from Uu to PC5 and vice versa may be up to higher layers.

The Remote WTRU may perform radio measurements at the PC5 interface and use them for ProSe WTRU-to-Network relay selection and reselection along with higher layer criterion. A ProSe WTRU-to-Network relay may be considered suitable in terms of radio criteria if the PC5 link quality exceeds a configured threshold, which may be pre-configured or provided by the eNB. The remote WTRU may select the ProSe WTRU-to-Network relay, which may satisfy higher layer criterion and have the best PC5 link quality among all suitable ProSe WTRU-to-Network relays. The remote WTRU may trigger ProSe WTRU-to-Network relay reselection when the PC5 signal strength of the current ProSe WTRU-to-Network relay is below the configured signal strength threshold and/or it receives an L2 link release message or other upper layer message from the ProSe WTRU-to-Network relay.

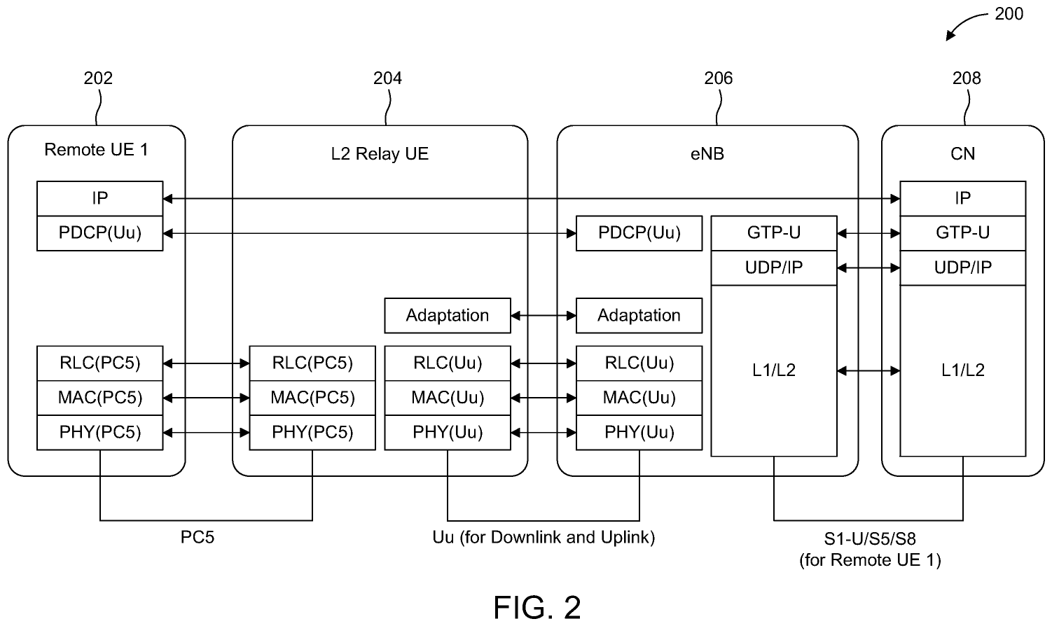

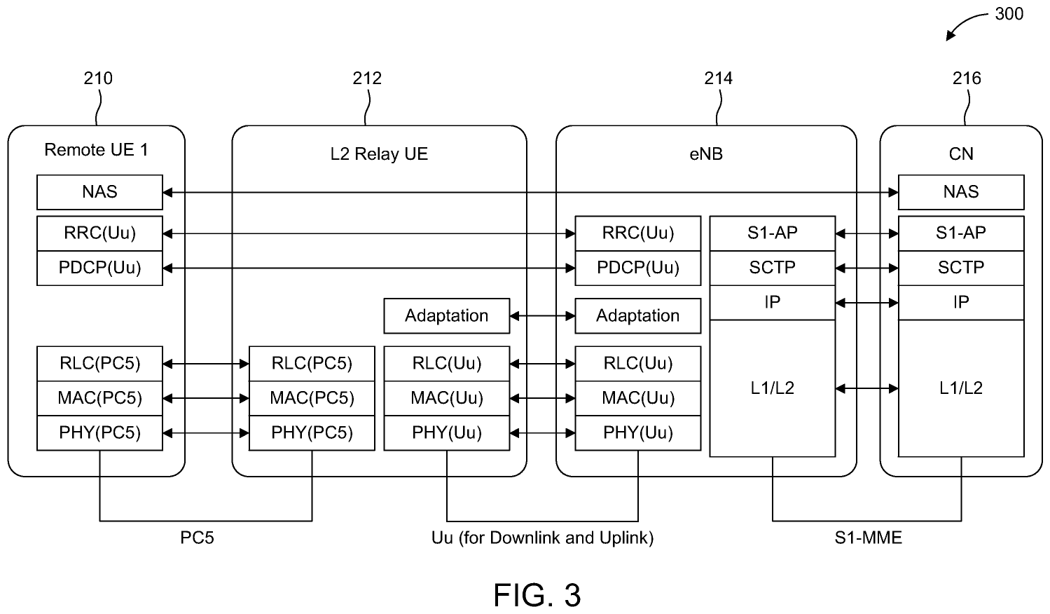

In 3GPP, a study for WTRU-to-Network relays for commercial use cases tailored to wearables and IoT devices was performed in RAN. While such study did not result in any specification, a technical report (TR) provided some potential options for such relays. Contrary to ProSe WTRU-to-Network relays, which use an L3 or IP layer relaying approach, the WTRU-to-Network relays for wearables was expected to be an L2 relay based on the protocol stacks shown in FIGS. 2 and 3.

FIG. 2 is a block diagram of an example user plane radio protocol stack 200 for an L2 evolved WTRU-to-Network relay (PC5). FIG. 3 is a block diagram of an example control plane radio protocol stack 300 for an L2 evolved WTRU-to-Network relay (PC5). In the examples illustrated in FIG. 2 and FIG. 3, for protocol architecture for the user plane and control plane, relaying is performed above the RLC sublayer. The control plane and the user plane of the evolved ProSe Remote WTRU 202/210 are relayed above RLC via the evolved ProSe WTRU-to-Network Relay WTRU 204/212 from the evolved Pro-Se Remote WTRU 202 to network 208/216 and vice versa. In the illustrated examples, Uu PDCP and RRC are terminated between the evolved ProSe Remote WTRU 202/210 and the eNB 206/214 while RLC, MAC, PHY and the non-3GPP transport layers are terminated in each link (e.g., the link between the evolved ProSe Remote WTRU 202/210 and the evolved ProSe WTRU-to-Network Relay WTRU 204/212 and the link between the evolved ProSe WTRU-to-Network Relay WTRU and the eNB 206/214).

Sidelink WTRU-to-Network relays in 3GPP Release 17 focused on the out of coverage (OOC) remote WTRU. It is expected that, in Release 18, enhancement may be made so that a remote WTRU can operate in multipath when in coverage. The multipaths may include, for example, one path over direct Uu and another path via the sidelink WTRU-to-Network relay.

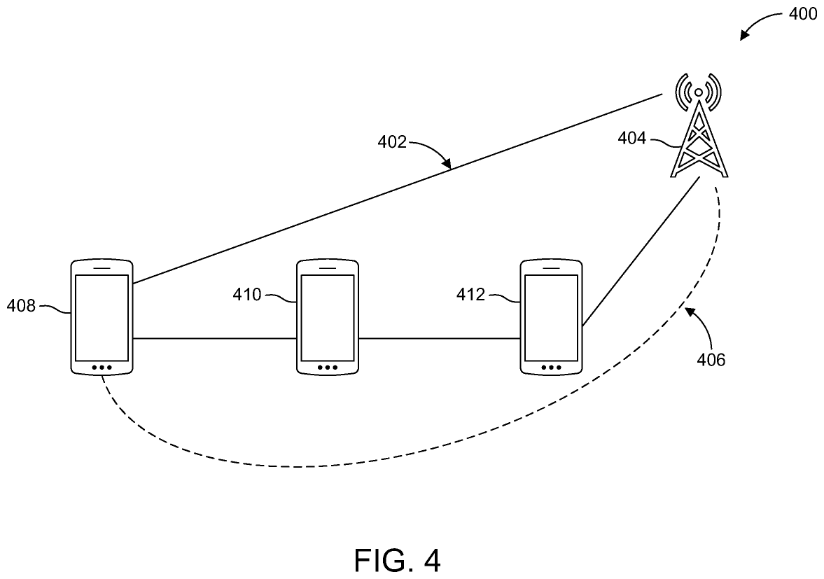

FIG. 4 is a network diagram of an example of multipath operation 400 of a remote WTRU 408 via direct (Uu) link 402 and relayed (PC5) link 406. In the example illustrated in FIG. 4, an example multipath operation is shown, where the sidelink path 406 may include more than one side relay 410, 412. There can, however, be different approaches on how the multipath link will be employed. In one example, the direct link 402 may be used only for control plane signaling while the sidelink 406 may be used for the user plane. In another example, the links can be employed just like in dual connectivity (DC) where both links 402, 406 are used for the control plane (CP) as well as user plane (UP) signaling. Thus, the WTRU 408 may be configured with some signaling radio bearers (SRBs) and data radio bearers (DRBs) that may be associated only with the direct path 402, only with sidelink 406, or both (e.g., a split bearer).

The packet data convergence protocol (PDCP) layer may provide its services to the radio resource control (RRC) layer in the CP or service data adaptation protocol (SDAP) layer in the UP. The PDCP layer may provide the following functionalities: transfer of user plane or control plane data; maintenance of PDCP Sequence Numbers (SNs); header compression and decompression; security (ciphering and integrity protection during transmission and deciphering and integrity verification during reception); timer based service data unit (SDU) discard; duplication; reordering and in-order delivery; out-of-order delivery; and duplicate discarding.

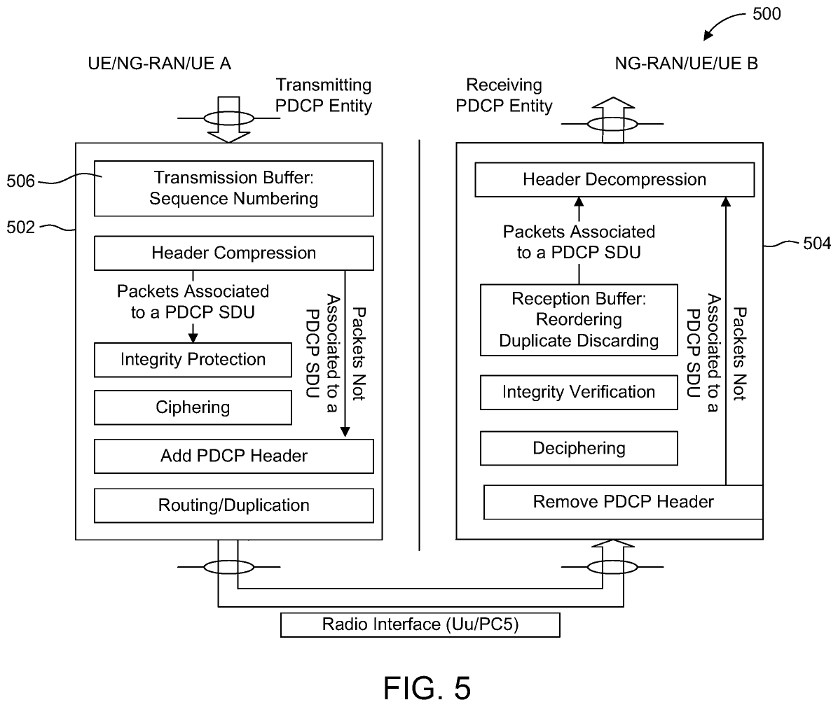

FIG. 5 is a functional view of an example PDCP layer 500. In the example illustrated in FIG. 5, the PDCP layer 500 includes a PDCP entity associated with each radio bearer (SRB or DRB), and the illustrated PDCP layer 500 has a transmitting entity 502 and a receiving entity 504. A PDCP entity, such as the PDCP entity 502, associated with a DRB, may be configured with a discardTimer. This timer may specify the maximum amount of time packets are held in the transmit buffer 506. That is, whenever the PDCP entity 502 receives a new packet from upper layers, a new timer with a value equal to the discardTimer may be started.

When the discardTimer expires for a PDCP SDU, or successful delivery of a PDCP SDU is confirmed by reception of a PDCP status report, the transmitting PDCP entity 502 may discard the PDCP SDU along with the corresponding PDCP protocol data unit (PDU). Thus, even after the PDCP SDU is transferred to RLC for transmission, the packet may be kept at the PDCP transmit buffer. This may typically be useful for failure recovery cases, such as re-establishment after a radio link failure (RLF). In such cases, a WTRU may re-establish the PDCP entity and transmit or retransmit all the SDUs that are still in the PDCP transmit buffer.

When upper layers request a PDCP entity re-establishment, the transmitting PDCP entity 506 may perform a number of different functions. For unacknowledged mode (UM) DRBs and acknowledged mode (AM) DRBs, the transmitting PDCP entity 502 may reset the robust header compression (ROHC) protocol for uplink and start with an initialization and refresh (IR) state in unidirectional mode (U-mode) (e.g., as defined in RFC 3095 and RFC 4815) if drb-ContinueROHC is not configured. For UM DRBs and AM DRBs, the ethernet header compression (EHC) protocol may be reset for uplink if drb-ContinueEHC-UL is not configured. For UM DRBs and SRBs, the transmitting PDCP entity 506 may set TX_NEXT to the initial value. For SRBs, the transmitting PDCP entity 506 may discard all stored PDCP SDUs and PDCP PDUs. The transmitting PDCP entity 506 may apply the ciphering algorithm and key provided by upper layers during the PDCP entity re-establishment procedure and/or apply the integrity protection algorithm and key provided by upper layers during the PDCP entity re-establishment procedure. For UM DRBs, for each PDCP SDU already associated with a PDCP SN but for which a corresponding PDU has not previously been submitted to lower layers, and, for AM DRBs for the Uu interface whose PDCP entities were suspended, from the first PDCP SDU for which the successful delivery of the corresponding PDCP Data PDU has not been confirmed by lower layers, for each PDCP SDU already associated with a PDCP SN: the transmitting PDCP entity 502 may consider the PDCP SDUs as received from upper layers and perform transmission of the PDCP SDUs in ascending order of the COUNT value associated with the PDCP SDU prior to the PDCP re-establishment without restarting the discardTimer. For AM DRBs whose PDCP entities were not suspended, from the first PDCP SDU for which the successful delivery of the corresponding PDCP Data PDU has not been confirmed by lower layers, the PDCP entity may perform retransmission or transmission of all the PDCP SDUs already associated with PDCP SNs in ascending order of the COUNT values associated to the PDCP SDU prior to the PDCP entity re-establishment as specified as: perform header compression of the PDCP SDU using ROHC as specified; perform integrity protection and ciphering of the PDCP SDU using the COUNT value associated with this PDCP SDU as specified; and submit the resulting PDCP Data PDU to lower layers.

As mentioned above, PDCP entities of a DRB may be configured with a discardTimer that specifies the maximum time a packet is stored at the PDCP transmit buffer before it can be discarded. Setting the value to a high value will ensure that UL packet loss will be prevented in cases like radio link failure (RLF) because the packets can be retransmitted during recovery via connection re-establishment. However, this may result in very high buffer size requirements at the WTRU (e.g., if there are DRBs with a very high data rate, and the network is not sending PDCP status reports that often). Setting a shorter discardTimer may alleviate the buffer size problem. However, this may increase the chances of UL packet loss because packets may be discarded even before their reception is acknowledged via a PDCP status report, and, thus, the WTRU may not have a chance to re-transmit them during failure recovery via re-establishment. Thus, the configuration of the discardTimer value may be a balancing act that may be done by the network that may consider, for example, WTRU buffer requirements, data rate of DRBs, latency, and/or frequency of status reports sent by the network.

For multipath operation, as described, for example, above with respect to FIG. 4, where there may be one or more hops on the sidelink path, and assuming the WTRU is configured with a split DRB, whereby some packets of the bearer are sent via the direct path and others via the sidelink path, in legacy PDCP, since a PDCP may be associated with only one discardTimer, packets belonging to the same DRB may be stored for the same maximum amount of time at the PDCP transmit buffer, whether they are transmitted via the direct link or the sidelink. Configuring the discardTimer to a smaller value (e.g., corresponding to the latency over the direct link) may result in earlier discard of packets that are sent via the sidelink, thereby increasing the probability of UL packet loss in the case of RLF and re-establishment. On the other hand, configuring the discardTimer to a large value (e.g., corresponding to the latency over the relayed link), may reduce the chances of UL packet loss in the case of RLF and re-establishment but may increase the buffer requirements on the WTRU as the packets that are sent via the direct link may be stored unnecessarily for a longer period than necessary.

Embodiments are described herein that may help better configure the discardTimer for multipath operation. This may be done, for example, for a given split bearer, by configuring the WTRU to apply different PDCP discard time durations for packets sent via different paths. Alternatively, or additionally, a WTRU may be configured to determine and/or adjust the PDCP discard timer value based on network and/or WTRU conditions (e.g., current UL buffer level, radio link quality, backhaul link quality, number of hops, and/or link congestion). A WTRU may be configured to monitor the time duration between packet reception at PDCP level and successful packet transmission at lower layers and use this to adjust PDCP discard time durations. While the embodiments described herein may be beneficial for multipath operation, at least some embodiments are equally applicable to single path operation where it may be desirable to adjust discardTimer values for the single path based on one or more associated conditions.

As used herein, the terms sidelink (SL) and relayed link may be used interchangeably. In the descriptions that follow, a scenario as in FIG. 4 may be assumed, where a WTRU is connected to a gNB via a direct link and a relayed link, wherein the relayed link may comprise multiple hops. However, one of ordinary skill in the art will understand that the embodiments described herein are equally applicable in scenarios where, instead of the relayed link via sidelink, the WTRU is connected via an integrated access and backhaul (IAB) node, which may be further connected to other IAB nodes. Additionally, at least some embodiments are equally applicable to single path scenarios where it may be desirable to make the discardTimer value changeable depending on certain conditions. Additionally, the embodiments described herein may be readily applicable to scenarios where a WTRU may have more than two paths to send UL data (e.g., a scenario where WTRUs can be connected to one primary node and more than one secondary node).

The term packet may refer to a PDCP service data unit (SDU), which may be one unit of data received from upper layers, such as a service data adaption protocol (SDAP). As used herein, the term start a timer may refer to starting a time period, with a duration from the current time to the current time plus the associated timer value, and timer expiry may refer to the current time becoming later than the end of the time period. Further, while timers are specifically mentioned herein as a means for measuring time, time periods may be measured by any type of device or means, including, but not limited to, timers, counters, clocks, or any other way of measuring a time period.

Some of the embodiments described herein are applicable to the case where the WTRU is configured with a split bearer, where the data for that bearer can be sent via the direct link or the relayed link. In these cases, it may be assumed that, as in the case of legacy dual connectivity, the direct path or the relayed path is configured as the primary path for the split bearer, where the WTRU normally uses it for sending UL data of that bearer. If the direct link is configured to be the primary link, then the relayed link may be considered to be the secondary link, and vice versa. A split buffer threshold may be configured for the split bearer that may indicate to the WTRU when it can start using the secondary path for that bearer. That is, when the amount of buffered UL data for that bearer is above the configured buffer threshold, the WTRU may start also using the secondary path for sending UL data for that bearer.

Some of the embodiments described herein may also be applicable to other scenarios where a WTRU is operating in dual connectivity and where the latency over one path may be considerably different from another path. Some examples include: two relayed links, where one relayed link is one hop and another relayed link has multiple hops; a direct link and another link via multiple IAB; and/or dual connectivity via two direct links but where one link may be experiencing different latency as compared to the other link (e.g., due to congestion, due to the frequency range used on one link leading to the sending of more/less data than the other link, etc.). As used herein, discarding a packet may mean that the packet will not be available for transmission or retransmission at the PDCP level afterwards (e.g., in case of recovery from RLF).

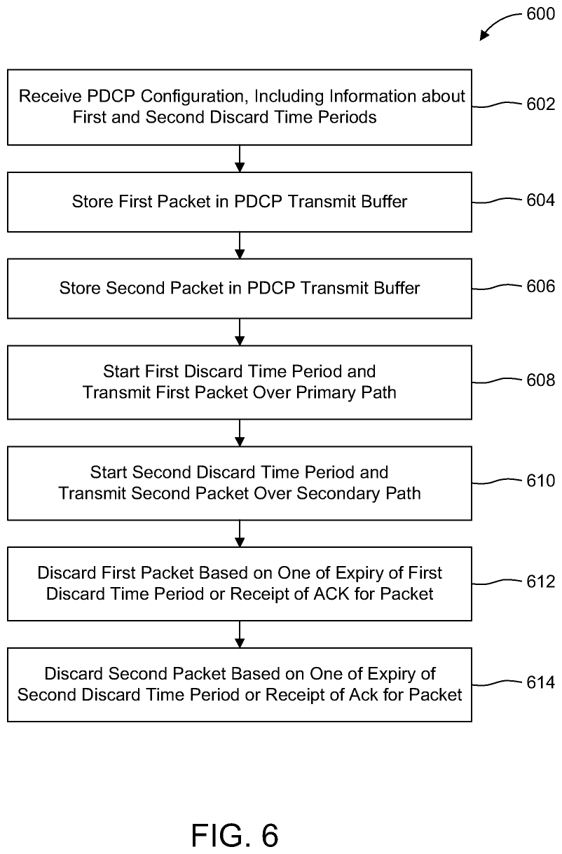

FIG. 6 is a flow diagram of an example method 600, which may be implemented in an apparatus, such as the WTRU illustrated in FIG. 1B and described above and, more specifically, may be implemented via a processor and/or a transceiver or other components of the WTRU. One of ordinary skill in the art will understand that, while the methods are described herein as implemented in a WTRU, similar methods may be implemented on the infrastructure side in an apparatus, such as in a base station (e.g., a gNB), or other network node, gateway, etc.

In the example illustrated in FIG. 6, the method includes receiving a PDCP configuration, which may include information about a first discard time duration and information about a second discard time duration (602). The PDCP configuration may be for a split bearer, the first discard time duration may be associated with a primary path, and the second discard time duration may be associated with a secondary path. A first packet may be received for transmission and stored in a PDCP transmit buffer (604). The packet may be received from an upper layer or upper layers. A second packet may be received for transmission and stored in the PDCP transmit buffer (606). Similar to the first packet, the second packet may be received from an upper layer or upper layers.

The first discard time period may be started, and the first packet may be transmitted over the primary path (608). The WTRU may hold, keep or maintain the first packet in the PDCP transmit buffer after the packet has been transmitted, for example in case it needs to be retransmitted due, for example, to radio link failure (RLF) or other channel conditions. The second discard time period may be started, and the second packet may be transmitted over the secondary path (610). Similar to the first packet, the WTRU may hold, keep or maintain the second packet in the PDCP transmit buffer after the packet has been transmitted, for example in case it needs to be retransmitted due, for example, to radio link failure (RLF) or other channel conditions. The first packet may be discarded from the PDCP transmit buffer based on one of expiry of the first time period or reception of an acknowledgement (ACK) for the first packet (612), for example from the base station, such as a gNB, whichever occurs first. Similarly, the second packet may be discarded from the PDCP transmit buffer based on one of expiry of the second time period or reception of an ACK for the second packet (614), for example from the base station, such as a gNB, whichever occurs first.

In embodiments such as described with respect to FIG. 6, a WTRU that is operating in multipath/DC operation and has a split bearer configured may be configured to use different discardTimer values when sending data over the secondary path as compared to the discard Timer value to be used for the primary path. For example, a split bearer may be configured with a first discard time duration (e.g. discardTimerPrimary) associated with the primary path and a second discard time duration (e.g. discardTimerSecondary) associated with the secondary path. For example, when a packet is sent via the primary path, a timer may be started with a value equal to discardTimerPrimary, and when a packet is sent via the secondary path, a timer may be started with a value equal to the discardTimerSecondary. The packet may remain in the PDCP transmit buffer until the timer associated with it expires or a PDCP status report or any type of acknowledgement (ACK) is received, for example from the network, that indicates that the packet has been received properly.

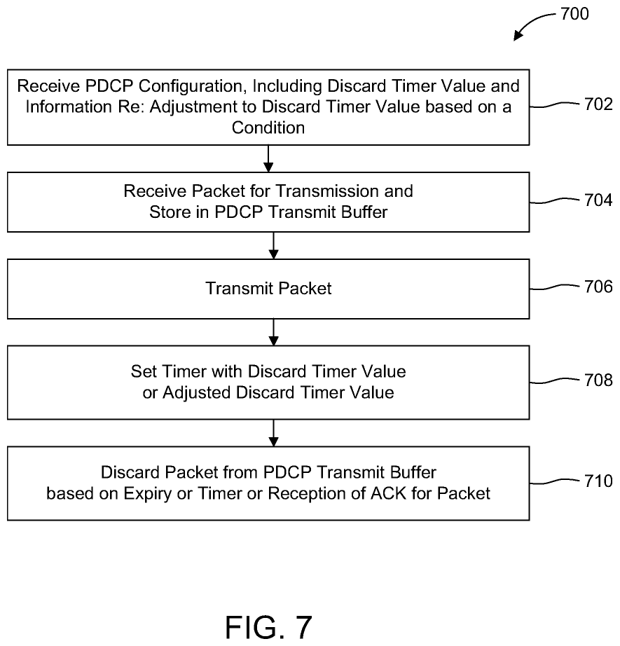

FIG. 7 is a flow diagram of another example method 700, which may be implemented in an apparatus, such as the WTRU illustrated in FIG. 1B and described above and, more specifically, may be implemented via a processor and/or a transceiver or other components of the WTRU. One of ordinary skill in the art will understand that, while the methods are described herein as implemented in a WTRU, similar methods may be implemented on the infrastructure side in an apparatus, such as in a base station (e.g., a gNB), or other network node, gateway, etc.

In the example illustrated in FIG. 7, the method includes receiving a PDCP configuration, which may include a discard time duration and information regarding adjustment to the discard time duration based on a condition (702). Example adjustments and conditions are described in more detail below. A packet may be received for transmission and stored in a PDCP transmit buffer (704). The packet may be received from an upper layer or upper layers. The packet may be transmitted (706). A timer may be set with the discard time duration or an adjusted discard time duration. The timer may be set with a value equal to the discard time duration based on the associated condition not being met. The timer may be set with a value equal to the discard time duration adjusted using the adjustment based on the associated condition being met. The WTRU may hold, keep or maintain the packet in the PDCP transmit buffer after the packet has been transmitted, for example in case it needs to be retransmitted, for example, due to radio link failure (RLF) or other channel conditions. The packet may be discarded from the PDCP transmit buffer based on expiry of the timer or reception of an acknowledgement (ACK) for the packet (710), for example from the base station, such as a gNB, whichever occurs first.

In some embodiments, instead of specifying two separate discard time durations for the split bearer as described above with respect to FIG. 6, the WTRU may be configured with a scaling factor that is to be used when sending data over the secondary path. For example, a split bearer may be configured with a discard time duration timervalue1 (as in legacy split bearer configuration) and a scaling factor of m, which may indicate to the WTRU that, for that particular bearer, when sending a packet over the secondary path (e.g., when the current UL buffer level is above the split buffer threshold), the WTRU will keep the packet in its PDCP transmission buffer for a maximum of m*timervalue1 while, for those packets transmitted over the primary path, the packet may be kept in the buffer for a maximum of timervalue1.

The scaling factor may be provided at the WTRU level (e.g., one scaling factor may be configured and used for all split bearers). For example, bearers with a certain property (e.g., QoS class, PDB value/range, etc.) could be configured to use the same delta value. In another example, the IDs of the bearers using the same scaling factor may be provided to the WTRU (e.g., bearers 1,2 use scaling factor a, bearers 3, 4, 5 use scaling factor b, etc.). In some embodiments, the scaling factor may be provided for a group/subset of bearers instead of individual bearers.

In some embodiments, rather than using a scaling factor, a delta value may be specified. For example, a split bearer may be configured with a discard time duration timervalue1 (as in legacy split bearer configuration) and a delta value of m for the secondary path, which may indicate to the WTRU that, for that particular bearer, when sending a packet over the secondary path (e.g., when the current UL buffer level is above the split buffer threshold), the WTRU will keep the packet in its PDCP transmission buffer for a maximum of timervalue1+m while, for those packets transmitted over the primary path, the packet may be kept in the buffer for a maximum of timervalue1.

The delta value may be provided at the WTRU level (e.g., one delta value may be configured and used for all split bearers). Additionally, or alternatively, the delta value may be provided for a group/subset of bearers instead of individual bearers. For example, bearers with a certain property (e.g., QoS class, PDB value/range, etc.) could be configured to use the same delta value. In another example, the IDs of the bearers using the same delta value may be provided to the WTRU (e.g., bearers 1,2 use delta value a, bearers 3, 4, 5 use delta value b, etc.).

A combination of the above described embodiments may also be possible. For example, a split bearer may be configured with both a scaling factor and a delta value to apply for the discard time duration associated with the secondary path (e.g., discard timer for the secondary path=a*timer1+b, where a is the scaling factor, b is the delta value, and timer1 is the discard time duration for the primary path).

In some embodiments, a WTRU may be configured to use a discardTimer value that is dependent on current network congestion. For example, a WTRU may be configured to adjust the discardTimer value used for a bearer whose data is being sent over a sidelink depending on the Channel Busy Ratio (CBR) and/or Channel Occupation Ratio (CR). In one example, a default discardTimer value may be used when the CBR is below a certain level (e.g., cbr_threshold_1), another value may be used when the CBR is between cbr_threshold_1 and cbr_threshold_2, and another value may be used when the CBR is above cbr_threshold_2. Instead of specifying different values for each range of CBR values, a scaling factor or a delta value can be specified that may be applied on top of the default timer value.

Such embodiments may be applicable to both single connectivity or multipath/dual connectivity. For example, in the multipath case where one link is sidelink and the other link is a direct link, the default discard time duration may be the value used for the direct link, and the values to be used for the sidelink can be configured to be the same as long as the CBR on the sidelink is below a certain threshold and scaling/delta values specified for CBR values (or range of values) are above that threshold. Such embodiments may also be applicable in scenarios where the radio link is operating in unlicensed spectrum. For example, the discard Timer value can be adjusted based on the listen before talk (LBT) failure rate or the detected/measured channel occupancy rate during unlicensed operation.

In some embodiments, a WTRU may be configured to use a discardTimer value that is dependent on the number of hops between the WTRU and the base station, for a given path used for sending UL data. In order to utilize this, the WTRU may acquire the number of hops information from the network via several means (e.g., broadcast information from a relay WTRU or an IAB node, explicitly configured, e.g., via RRC, during a handover to a relay WTRU or an IAB node or a secondary node/path addition of a SL or an IAB node, etc.). In one example, a default discardTimer value may be used when the number of hops is one (e.g., direct link), another value may be used when the number of hops is 2, another value may be used when the number of hops is 3, and another value may be used when the number of hops is above 3, etc. Instead of specifying different values for each hop count (or range of hop count values), a scaling factor or a delta value can be specified that is applied on top of the default timer value.

Such embodiments may be applicable to both single connectivity or multipath/dual connectivity. For example, in the multipath case, where one link is sidelink (or via IAB link) and the other link is a direct link, the default discard time duration may be the value used for the direct link, and the values to be used for the sidelink may be adjusted (e.g., scaled, delta values applied), depending on the determined hop count for the relayed path.

In some embodiments, a WTRU may be configured to use a discardTimer value that is dependent on current radio link quality (e.g., RSRP, reference signal received quality (RSRQ), etc.). In one example, a default discardTimer value may be used when the radio link quality is above a certain level (e.g., rsrp_threshold_1), another value may be used when the radio link quality is between rsrp_threshold_1 and rsrp_threshold_2, and another value may be used when the radio link quality is below rsrp_threshold_2. Instead of specifying different values for each range of radio quality levels, a scaling factor or a delta value can be specified that may be applied on top of the default timer value.

If the concerned path is comprised of multiple hops (e.g., WTRU connected via SL or IAB node), the radio link based discard Timer adjustment may take into account the radio link conditions of the one or more hops after the first hop between the WTRU and the first relay WTRU/IAB node. In order to utilize this, the WTRU may acquire the information about the quality of the one or more backhaul hops from the network via several means (e.g., broadcast information from a relay WTRU or an IAB node, explicitly communicated via RRC from the gNB, communicated from the relay WTRU or an IAB node via a MAC CE, etc.). In one example, the information about the radio link quality of the one or more backhaul hops can be used to scale/adjust the radio link measurement that the WTRU has gathered on the first hop, before it is compared with the configured thresholds for updating the discard time durations. In another example, the WTRU may be configured with different discard time duration ranges (or scaling factors or delta values) that are dependent only on the radio link quality of the one or more backhaul hops.

The above may be applicable to both single connectivity or multipath/dual connectivity. For example, in the multipath case, where one link is sidelink and the other one is a direct link, there may be several possibilities. One possibility is that the discard time duration to be used and how it is to be updated (e.g., based on current RSRP range/value) may be configured independently for each link (e.g., different ranges and discard time durations, scaling factors, or delta values configured separately for each link). Another possibility is that the discard time duration to be used for one link (e.g., direct link) may be used as a baseline, and the discard time duration for the other link (e.g., sidelink) may be an updated value from this default value based on the radio link conditions of the second link. Another possibility is that the discard time duration to be used for one link (e.g., direct link) may be used as a baseline, and the discard time duration for the other link (e.g., sidelink) may be an updated value from this default value based on the difference (e.g., relative, absolute) radio link conditions of the two links.

In some embodiments, a WTRU may be configured to use a discardTimer value that is dependent on WTRU buffer utilization. In one example, a default discardTimer value may be used when the UL buffer level is below a certain level (e.g., buffer_threshold_1), another value may be used when the buffer level is between buffer_threshold_1 and buffer_threshold_2, and another value may be used when the buffer level is above buffer_threshold_2. Instead of specifying different values for each range of buffer levels, a scaling factor or a delta value can be specified that may be applied on top of the default timer value. The buffer thresholds/levels may be specified per each bearer. The thresholds/levels may be concerning the total UL buffer level. The buffer thresholds/levels may be concerning the available/remaining buffer level. The buffer thresholds/levels may be concerning the already used buffer level.

In some embodiments, a WTRU may be configured to use a discardTimer value that is dependent on the UL data rate (e.g., instantaneous value, averaged over a certain period, etc.). In one example, a default discardTimer value may be used when the UL data rate is below a certain level (e.g., datarate_threshold_1), another value may be used when the data rate is between datarate_threshold_1 and datarate_threshold_2, and another value may be used when the data rate is above datarate_threshold_2. Instead of specifying different values for each range of data rate levels, a scaling factor or a delta value can be specified that may be applied on top of the default timer value. The data rate thresholds/levels may be specified per each bearer. The data rate thresholds/levels may be concerning the total UL data rate.

In some cases, for the sake of reliability, PDCP duplication maybe configured for certain bearers, where the same PDCP packet may be duplicated and sent via multiple paths (in the case of multiple connectivity) or different carriers (in the case of carrier aggregation (CA)-based duplication). The discard time duration associated with a duplicated packet may be configured to be equal to the maximum of the discard time durations determined to be used for the two paths, according to any of the embodiments described herein. The discard time duration associated with a duplicated packet may be configured to be equal to the minimum of the discard time durations determined to be used for the two paths, according to any of the embodiments described herein. The discard time duration associated with a duplicated packet may be configured to be equal to the average of the discard time durations determined to be used for the two paths, according to any of the embodiments described herein. The WTRU may be configured to restart (or increase or decrease the remaining time) of the discard timers that are already running for packets (e.g., packets that are already transmitted and the acknowledgement of which is not received or packets that are waiting to be transmitted). In one example, the WTRU may be configured to increase the remaining time of an already running discard time, based on any of the conditions/factors described herein (e.g., radio congestion increasing on the link over which the packet was sent as detected from increasing CBR or LBT failures, radio link quality degrading, etc.).

When the WTRU has more than one path to send the packet, it may be configured to start the discard timer immediately on packet reception at PDCP (e.g., before a decision is made to which path the packet is to be sent). Once the decision has been made, the concerned time may be restarted/adjusted to reflect the changes. For example, the PDCP may always start the timer with the longest discardTimer value among the two paths upon packet reception from the higher layers, and if the path with the shorter discard timer is chosen to send the data, the timer may be restarted with the shorter duration or the remaining timer value is adjusted to reflect the changes.

In some embodiments, the WTRU may be configured to monitor the time duration between packet arrival at the PDCP level to the proper transmission of all the lower layer PDUs that are part of this packet (e.g., RLC PDUs, MAC PDUs, etc.) and use this information to update the discard time durations to be used at the PDCP level. For example, the WTRU, upon determining that the concerned time duration has increased by a certain factor, may increase the discard time duration accordingly. Scaling factors, delta values or duration thresholds can be configured, which the WTRU can use to do this adjustment (e.g., use the default discard timer as long as the measured time duration is below a certain threshold, apply a specified delta on top of this default value if the measured time duration is between certain threshold levels, etc.).

When the WTRU has multiple paths available and has determined different discard time durations for each path according to any of the embodiments described herein, the current discard time duration on each path may be used to determine which path is selected for sending upcoming/pending UL packets. In one example, the WTRU may be configured to prioritize sending UL data via the path that has a lower discardTimer value associated with it. In another example, the WTRU may be configured to prioritize sending UL data over the path that has a higher discardTimer value associated with it. Here, prioritization could mean for the WTRU to try to be scheduled first over one path (e.g., sending buffer status report, scheduling request, etc.). If the WTRU does not get scheduled over the prioritized path for a certain duration (e.g., a duration that is equal or is of a certain factor of the discard time duration between the two paths), the WTRU may be configured to try to get scheduled over the other path (and may also be configured to adjust/restart the discard time duration that is already running for that packet, if the discard timer was started when the decision was made to send the data via the first path).

A combination of some or all of the embodiments described herein is possible. For example, a WTRU may be configured with thresholds for updating the discard timers based on network congestion, radio signal levels, WTRU buffer levels, etc. If more than one condition is fulfilled (e.g., the radio level is below a threshold configured to adjust the timer, and, at the same time, the UL buffer level is above a threshold configured to adjust the timer), the WTRU may be configured to apply one or more of the following: use a configured priority among the different conditions (e.g., buffer level considerations have the highest priority, etc.), and consider/apply the adjustment that is associated with the highest priority condition that is fulfilled; apply the different discardTimer adjustments independently for each fulfilled condition; apply the most relaxed adjustment (e.g., apply the minimum scaling or delta value, among the conditions that are currently fulfilled); apply the most strict adjustment (e.g., apply the maximum scaling or delta value), apply a value that is an average of the adjustment values associated with the fulfilled conditions, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) comprising:
a processor; and
a transceiver in communication with the processor,
wherein the processor and the transceiver are configured to receive packet data convergence protocol (PDCP) configuration information for a split bearer, wherein the PDCP configuration information includes information about a first discard time period and information about a second discard time period,
wherein the processor is further configured to store a first packet and a second packet in a PDCP transmit buffer,
wherein the processor and the transceiver are further configured to:
start the first discard time period and transmit the first packet over a primary path,
start the second discard time period and transmit the second packet over a secondary path,
discard the first packet stored in the PDCP transmit buffer based on a first one of expiry of the first discard time period or reception of an acknowledgement (ACK) for the first packet,
discard the second packet stored in the PDCP transmit buffer based on a first one of expiry of the second discard time period or reception of an ACK for the second packet, and
reduce or extend at least one of the first discard time period or the second discard time period based on at least one parameter.

2. The WTRU of claim 1, wherein one of a direct link to a base station and a relayed link to the basestation is configured as the primary path for the split bearer.

3. The WTRU of claim 1, wherein one of a direct link to a base station and a relayed link to the base station is configured as the secondary path for the split bearer.

4. The WTRU of claim 1, wherein the WTRU is configured to maintain the first packet in the PDCP transmit buffer after transmission of the first packet over one of the primary path or the secondary path until the first packet is discarded.

5. The WTRU of claim 1, wherein the processor and the transceiver are configured to:
transmit the first packet over the primary path after both starting the first discard time period and passing the first packet to lower layers, and
transmit the second packet over the primary path after both starting the second discard time period and passing the second packet to lower layers.

6. The WTRU of claim 5, wherein the first packet transmitted over the primary path is contained in a first transport block, and the second packet transmitted over the secondary path is contained in a second transport block.

7. The WTRU of claim 1, wherein the information about the first discard time period and the second discard time period are received via a radio resource configuration (RRC) re-configuration message.

8. The WTRU of claim 1, wherein the information about the first discard time period and the second discard time period includes a first value for the first discard time period and a second, different value for the second discard time period.

9. The WTRU of claim 1, wherein the information about the first discard time period includes a value for the first discard time period and the information about the second discard time period includes one of a scaling factor or a delta value.

10. (canceled)

11. A method, implemented in a wireless transmit/receive unit (WTRU), the method comprising:
receiving packet data convergence protocol (PDCP) configuration information for a split bearer, wherein the PDCP configuration information includes information about a first discard time period and information about a second discard time period,
storing a first packet and a second packet in a PDCP transmit buffer,
starting the first discard time period and transmitting the first packet over a primary path,
starting the second discard time period and transmitting the second packet over a secondary path,
discarding the first packet stored in the PDCP transmit buffer based on a first one of expiry of the first discard time period or reception of an acknowledgement (ACK) for the first packet, and
discarding the second packet stored in the PDCP transmit buffer based on a first one of expiry of the second discard time period or reception of an ACK for the second packet; and
reducing or extending at least one of the first discard time period or the second discard time period based on at least one parameter.

12. The method of claim 11, wherein one of a direct link to a base station and a relayed link to the basestation is configured as the primary path for the split bearer.

13. The method of claim 11, wherein one of a direct link to a base station and a relayed link to the base station is configured as the secondary path for the split bearer.

14. The method of claim 11, wherein the first packet is maintained in the PDCP transmit buffer after transmission of the first packet over one of the primary path or the secondary path until the first packet is discarded.

15. The method of claim 11, wherein:
the first packet is transmitted over the primary path after starting the first discard time period and passing the first packet to lower layers, and
the second packet is transmitted over the secondary path after starting the second discard time period and passing the second packet to lower layers.

16. The method of claim 15, wherein the first packet transmitted over the primary path is contained in a first transport block, and the second packet transmitted over the secondary path is contained in a second transport block.

17. The method of claim 11, wherein the first discard time period and the second discard time period are received via a radio resource configuration (RRC) re-configuration message.

18. The method of claim 11, wherein the information about the first discard time period and the second discard time period includes a first value for the first discard time period and a second, different value for the second discard time period.

19. The method of claim 11, wherein the information about the first discard time period includes a value for the first discard time period and the information about the second discard time period includes one of a scaling factor or a delta value.

20. (canceled)
